(19) United States
(12) Patent Application Publication
(10) Pub. No.: US 2026/0200290 A1
(43) Pub. Date: Jul. 16, 2026

(54) MULTIPLE CHILLER REFRIGERANT SYSTEM AND METHOD

(71) Applicant: GM GLOBAL TECHNOLOGY OPERATIONS LLC, Detroit, MI (US)

(72) Inventor: Nathan John English, Brighton, MI (US)

(73) Assignee: GM GLOBAL TECHNOLOGY OPERATIONS LLC, Detroit, MI (US)

(21) Appl. No.: 19/023,580

(22) Filed: Jan. 16, 2025

(51) Int. Cl. B60H 1/32; B60H 1/00

(52) U.S. Cl. CPC B60H 1/3205; B60H 1/00278; B60H 1/00878; B60H 2001/00307; B60H 2001/00928

(57) ABSTRACT

Refrigerant systems and methods include a multiple chiller architecture. A system for thermal control includes a compressor, a condenser, a first chiller, and a second chiller. A refrigerant circuit is included in which the compressor, the condenser, the first chiller and the second chiller are connected. A controller simultaneously operates the first and the second chillers at different operating temperatures.

### INTRODUCTION

The technical field generally relates to refrigerant systems, and more particularly relates to refrigerant systems for applications such as electric vehicles that use heat pump type circuits with a heating loop and a cooling loop that has multiple chillers for providing cooling at multiple temperatures.

Heating and cooling systems such as heating ventilating and air conditioning (HVAC) systems are employed in a wide range of manufactured products such as vehicles and other equipment and applications. Various types of refrigerants may be employed with a wide variety of system configurations. In many applications, heating and cooling for human comfort is employed. In additional applications, heating and/or cooling of devices may be desirable. For example, in electrified vehicles cooling may be provided for a battery pack, power electronics, motors, and/or other components.

Heat pump type refrigerant circuits move heat from one medium to another. Heat is taken from a source that may be a heat sink or a heat generator and moved to a destination that may provide warming for a desired function or simply to expel the heat from the system. To move heat, a transfer mechanism conveys the heat from a higher temperature medium to a lower temperature medium. For example, a metallic body at an elevated temperature gives up heat to its surrounding environment. The transfer of heat may be effected through mechanisms such as convection, conduction and radiation. Various types of heat exchangers may be connected in circuits that provide a controlled movement working fluids to move heat. In applications such as electric vehicles, providing the desired amount of cooling and heating for a variety of purposes may become complex.

Accordingly, there is an ongoing desire for simplified systems that deliver desirable cooling and/or heating requirements, while doing so in an efficient and low mass manner. There is also a desire to provide cooling and/or heating at a variety of temperatures. Furthermore, other desirable features and characteristics of the present disclosure will become apparent from the subsequent detailed description and the appended claims, taken in conjunction with the accompanying drawings and the foregoing introduction.

### SUMMARY

Refrigerant systems and methods include a multiple chiller architecture. In a number of embodiments, a system for thermal control includes a compressor, a condenser, a first chiller, and a second chiller. A refrigerant circuit is included in which the compressor, the condenser, the first chiller and the second chiller are connected. A controller simultaneously operates the first and the second chillers at different operating temperatures.

In additional embodiments, a valve is disposed upstream from the first chiller in the refrigerant circuit. The controller is in communication with the valve to control the valve to inject refrigerant in vapor form from the first chiller into the compressor.

In additional embodiments, a valve is disposed upstream from the first chiller in the refrigerant circuit. A cooling unit is coupled in a secondary cooling circuit with the first chiller. The controller is in communication with the valve to control the valve to inject refrigerant in vapor form from the first chiller into the compressor including when the cooling unit has no cooling demand.

In additional embodiments, a cooling unit is coupled in a first secondary cooling circuit with the first chiller. A cabin HVAC unit is connected in a second secondary cooling circuit with the second chiller. The controller operates the first chiller when the cooling unit has no demand to inject vapor into the compressor.

In additional embodiments, a cooling unit is coupled in a first secondary cooling circuit with the first chiller. An HVAC unit is connected in a second secondary cooling circuit with the second chiller. The controller operates the first chiller using mass flow control when the second chiller has a higher load demand than the first chiller.

In additional embodiments, a cooling unit is coupled in a first secondary cooling circuit with the first chiller. An HVAC unit is connected in a second secondary cooling circuit with the second chiller. The controller operates the first chiller with a superheat control when the second chiller has no load demand.

In additional embodiments, a cooling unit is coupled in a first secondary cooling circuit with the first chiller. An HVAC unit is connected in a second secondary cooling circuit with the second chiller. The controller operates the second chiller with superheat control when the first chiller has no load demand.

In additional embodiments, a cooling unit is coupled in a first secondary cooling circuit with the first chiller. An HVAC unit is connected in a second secondary cooling circuit with the second chiller. The controller operates both the first chiller and the second chiller with superheat control when there is a load demand below a high load threshold on both the first chiller and the second chiller.

In additional embodiments, a cooling unit is coupled in a first secondary cooling circuit with the first chiller. An HVAC unit is connected in a second secondary cooling circuit with the second chiller. The controller operates the second chiller with superheat control and the first chiller with mass flow control when there is no load demand on the first chiller and a load demand on the second chiller above a high load threshold.

In additional embodiments, a three-way valve is connected in the refrigerant circuit between the first and second chillers and the compressor.

In a number of additional embodiments, a method for thermal control includes constructing a refrigerant circuit in which a compressor, a condenser, a first chiller and a second chiller are connected. The first and the second chillers are operated simultaneously by a controller at different operating temperatures.

In additional embodiments, a valve is disposed upstream from the first chiller in the refrigerant circuit. The controller is in communication with the valve and controls the valve to inject refrigerant in vapor form from the first chiller into the compressor.

In additional embodiments, a valve is disposed upstream from the first chiller in the refrigerant circuit. A cooling unit is coupled in a secondary cooling circuit with the first chiller. The controller is in communication with the valve and controls the valve to inject refrigerant in vapor form from the first chiller into the compressor including when the cooling unit has no cooling demand.

In additional embodiments, a cooling unit is coupled in a first secondary cooling circuit with the first chiller. A cabin HVAC unit is connected in a second secondary cooling circuit with the second chiller. The controller, when the cooling unit has no demand, operates the first chiller to inject vapor into the compressor.

In additional embodiments, a cooling unit is coupled in a first secondary cooling circuit with the first chiller. An HVAC unit is connected in a second secondary cooling circuit with the second chiller. The controller operates the first chiller using mass flow control when the second chiller has a higher load demand than the first chiller.

In additional embodiments, a cooling unit is coupled in a first secondary cooling circuit with the first chiller. An HVAC unit is connected in a second secondary cooling circuit with the second chiller. The controller operates the first chiller with a superheat control when the second chiller has no load demand.

In additional embodiments, a cooling unit is coupled in a first secondary cooling circuit with the first chiller. An HVAC unit is connected in a second secondary cooling circuit with the second chiller. The controller operates the second chiller with superheat control when the first chiller has no load demand.

In additional embodiments, a cooling unit is coupled in a first secondary cooling circuit with the first chiller. An HVAC unit is connected in a second secondary cooling circuit with the second chiller. The controller operates both the first chiller and the second chiller with superheat control when there is a load demand below a high load threshold on both the first chiller and the second chiller.

In additional embodiments, a cooling unit is coupled in a first secondary cooling circuit with the first chiller. An HVAC unit is connected in a second secondary cooling circuit with the second chiller. The controller operates the second chiller with superheat control and the first chiller with mass flow control when there is no load demand on the first chiller and a load demand on the second chiller above a high load threshold. A three-way valve is connected in the refrigerant circuit between the first and second chillers and the compressor.

In a number of other embodiments, a system for thermal control in a vehicle includes a compressor having a primary port and a secondary port. A condenser is connected in a secondary heating circuit with and HVAC unit. A first chiller is connected in a first secondary cooling circuit with a cooling unit of a battery pack. A second chiller is connected in a second secondary cooling circuit with the HVAC unit. A refrigerant circuit is included in which the compressor, the condenser, the first chiller and the second chiller are connected. A three-way valve is connected in the refrigerant circuit between the first and second chillers and the compressor. The three-way valve is coupled with the compressor at both the primary port and the secondary port. A controller simultaneously operates the first and the second chillers at different operating temperatures.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a thermal management system with a multiple chiller refrigerant system, in accordance with various embodiments;

FIG. 2 is a schematic diagram of the thermal management system of the vehicle of FIG. 1, in accordance with various embodiments;

FIG. 3 is a circuit diagram of the multiple chiller refrigerant system of FIGS. 1 and 2, in accordance with various embodiments;

FIG. 4 is a flow chart of a process employing the multiple chiller refrigerant system of FIG. 3, in accordance with various embodiments; and

FIG. 5 is a logic matrix chart showing control actions for various cooling requirements of the multiple chiller refrigerant system of FIGS. 1-4, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

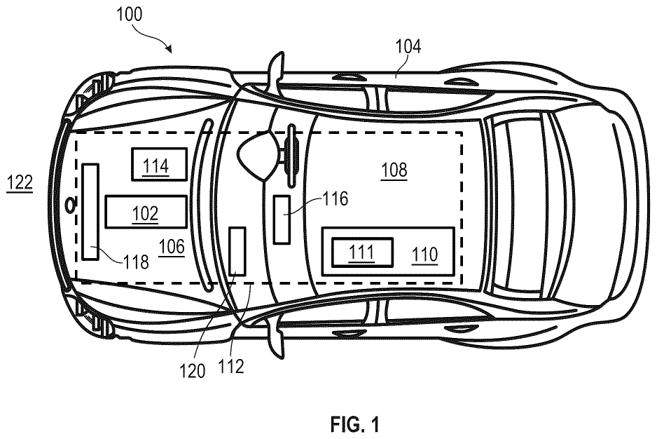

FIG. 1 illustrates a vehicle 100, according to an exemplary embodiment. In general, the vehicle 100 includes a powertrain 102 that operates to propel the vehicle 100. In some embodiments, the vehicle 100 comprises an automobile. In various embodiments, the vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise one or more other types of vehicles. In addition, in various embodiments, it will also be appreciated that the vehicle 100 may comprise any number of other types of mobile platforms. In the depicted embodiment, the body 104 of the vehicle 100 substantially encloses other components of the vehicle 100 and defines an engine compartment 106 and a cabin 108 that is configured to carry occupants.

In various embodiments, powertrain 102 propels the vehicle 100. The powertrain 102 preferably comprises a propulsion system. In certain exemplary embodiments, the powertrain comprises an internal combustion engine and/or an electric motor/generator. By way of example, the vehicle 100 may also incorporate any one of, or combination of, a number of different types of powertrains 102, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

For purposes of the current embodiment, the powertrain 102 is configured with electrified propulsion. As such, the vehicle 100 includes a battery pack 110. The battery pack may be disposed, at least in part, under the cabin 108 and provides energy for the powertrain 102. When doing so, or when in a charging state, the battery pack 110 may generate heat and so cooling is provided through the circulation of a fluid to the battery pack 110 and specifically its cooling unit 111 to extract and move the heat through a thermal management system 112.

The thermal management system 112, in general, also includes a refrigerant system 114, a cabin HVAC unit 116, a radiator unit 118 and a controller 120. The thermal management system 112 may interface with various other systems and components. In embodiments, the powertrain 102 is also included in the thermal management system 112. The thermal management system 112 includes various other components as described in more detail below. The thermal management system 112 operates to move heat from one place to another in relation to the vehicle and its features.

For purposes of the current disclosure, the powertrain 102, the battery pack 110, and the cabin HVAC unit 116 may be considered representative of a variety of destinations for which the refrigerant system 114 provided cooling. The cabin HVAC unit 116 may be considered representative of a variety of destinations for which the refrigerant system 114 provides heat. The radiator unit 118 may be considered representative of devices that expel heat from the refrigerant system 114 to the environment 122 surrounding the vehicle 100. The cabin HVAC unit 116 may have a heater heat exchanger, a cooling heat exchanger and a fan for forcing cabin air over the two. The radiator unit 118 may include at least one heat exchanger and a fan for drawing air across it.

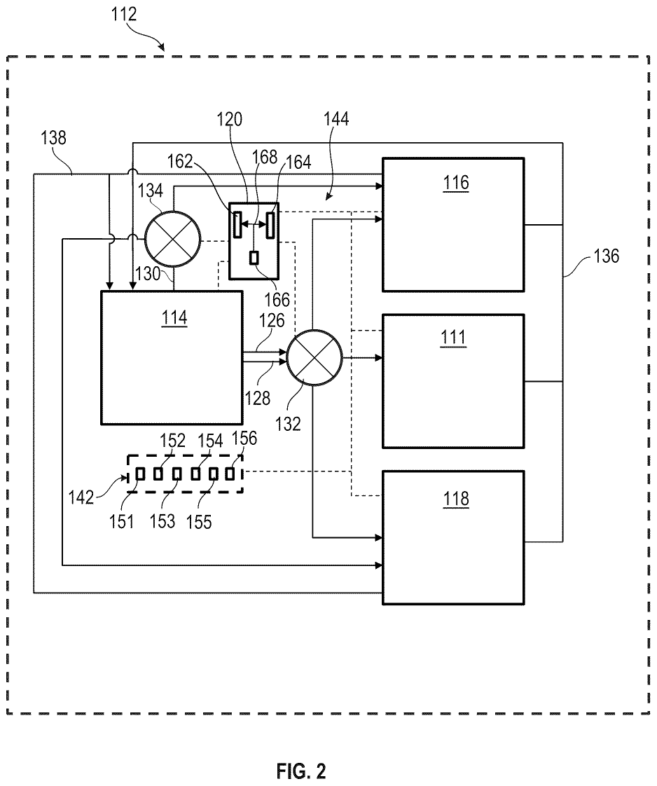

Referring to FIG. 2, aspects of the thermal management system 112 including the refrigerant system 114 are shown. As will be appreciated by one skilled in the art, the thermal management system 112 may include any number of other components that are omitted here for simplicity and as being ancillary to the present disclosure. The refrigerant system 114 has various outputs including a cool output 126, a cool output 128, and a heat output 130. In general, the cool outputs 126 and 128 may deliver a coolant, such as water or water with an antifreeze agent, at two different temperatures for cooling purposes. The heat output 130 may deliver a coolant, such as water or water with an antifreeze agent at an elevated temperature for heat expulsion purposes. The cool outputs 126 and 128 may be delivered to a control system that includes at least one mixing valve 132 to control the temperature of the coolant delivered downstream. In other embodiments, direct delivery may be provided from the cool outputs 126 and/or 128 to downstream devices or another valve/control arrangement may be employed. The heat output 130 may be delivered to a control system that includes at least one directional control valve 134 to control the direction of the coolant delivered downstream. In other embodiments, direct delivery may be provided from the heat output 130 to downstream devices or another valve/control arrangement may be employed.

The cool outputs 126 and/or 128 are delivered to any or all of a number of destinations served by the refrigerant system 114 such as the cabin HVAC unit 116, the cooling unit 111 and/or, in some embodiments, the radiator unit 118. The coolant delivered to the destinations is returned to the refrigerant system 114 through a return circuit 136. The heat output 130 is delivered to the cabin HVAC unit 116, the radiator unit 118 and/or other destinations served by the refrigerant system 114. The coolant delivered to the various destinations and is returned to the refrigerant system 114 through a return circuit 138.

The thermal management system 112 includes the controller 120, which is communicatively coupled with the cooling unit 111, the refrigerant system 114, the cabin HVAC unit 116, the radiator unit 118, the mixing valve 132, the control valve 134 and a sensor array 142. The sensor array 142 includes a number of sensors such as temperature sensors, pressure sensors, position sensors, mass flow sensors, and other sensors for monitoring and providing data representative of various parameters such as of the thermal management system 112, the vehicle 100 and the environment 122.

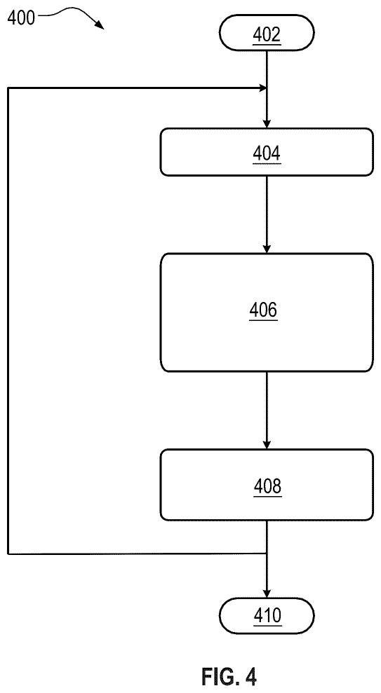

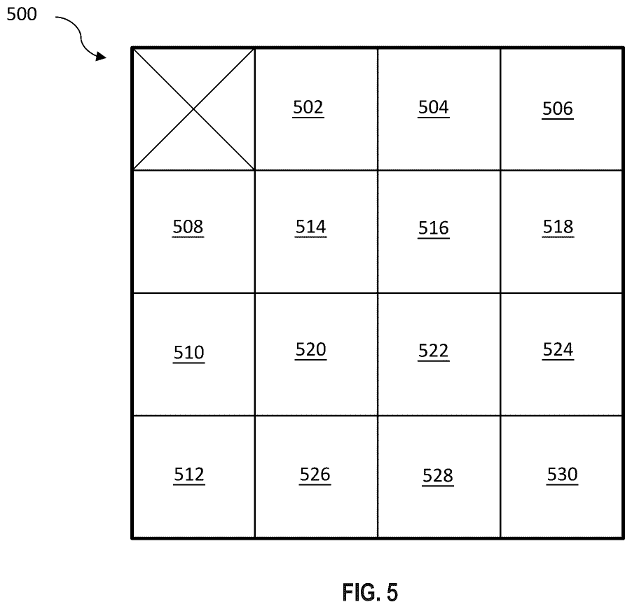

The controller 120 may be one or a plural number of controllers. The controller 120 is part of a control system 144 to monitor and control features of the thermal management system 112 and may be associated with various systems of the vehicle 100 including the refrigerant system 114. In various embodiments, the control system 144 provides instructions for controlling various aspects of the thermal management system 112 including through the actuators associated with various devices and systems. In various embodiments, the control system 144 comprises an electronic control module. Among other functionality, the control system 144 selectively controls operation of the refrigerant system 114. In various embodiments, the control system 144 provides functions in accordance with the steps of the method described further below in connection with FIG. 4 and the operations of the logic matrix/chart of FIG. 5.

As depicted in FIG. 2, in various embodiments, the control system 144 includes the controller 120 and those devices communicatively coupled with it including the sensor array 142. In some embodiments, the various devices include actuators that may be considered a part of the control system. In various embodiments, the sensor array 142 includes sensors for measuring observable conditions, including those of the thermal management system 112, and for generating sensor data based thereon. As depicted in FIG. 2, in various embodiments, the sensor array 142 includes sensors 151-155 such that various temperatures, pressures, positions, mass flow, and other observable parameters are measured. In certain embodiments, the sensor array 142 may also include one or more other sensors 156, for example to monitor activation/operation of the powertrain 102, and/or of other systems and devices of the vehicle 100. For example, in certain embodiments, the other sensors 156 may include one or more sensors for detecting when the powertrain system 102 is turned on and/or running, and other sensors as useful for the application.

In various embodiments, the controller 120 is coupled with the sensor array 142 and provides instructions for controlling the refrigerant system 114 and the thermal management system 112 such as through actuators via commands based on the sensor data. As depicted in FIG. 2, the controller 120 comprises a computer system. In certain embodiments, the controller 120 differ from the embodiment depicted in FIG. 2. For example, the controller 120 may be coupled with or may otherwise utilize one or more additional computer systems and/or other control systems, for example as part of one or more of the above-identified devices and systems of the vehicle 100.

In the depicted embodiment, the computer system of the controller 120 includes a processor 162, a memory 164, a storage device 166, and a bus 168. The processor 162 performs the computation and control functions of the controller 120, and may comprise any type of processor or multiple processors, single integrated circuits such as a microprocessor, or any suitable number of integrated circuit devices and/or circuit boards working in cooperation to accomplish the functions of a processing unit. During operation, the processor 162 executes one or more programs contained within the memory 164 and, as such, controls the general operation of the controller 120 and the computer system of the controller 120 in executing the processes described herein, such as the processes discussed further below in connection with FIG. 4 and the logic of FIG. 5.

The memory 164 may be any type of suitable memory. For example, the memory 164 may include various types of dynamic random access memory (DRAM) such as SDRAM, the various types of static RAM (SRAM), and the various types of non-volatile memory (PROM, EPROM, and flash). In the depicted embodiment, the memory 164 stores the above-referenced programs along with one or more stored values (e.g., including, in various embodiments, predetermined threshold or target values for controlling the mixing valve 132 and the control valve 134).

The storage device 166 may be any suitable type of storage apparatus, including various different types of direct access storage and/or other memory devices. In one exemplary embodiment, the storage device 166 comprises a program product from which the memory 164 receives programs that execute one or more embodiments of one or more processes of the present disclosure, such as the steps of the processes discussed further below in connection with FIG. 4 and the logic of FIG. 5. In another exemplary embodiment, the program product may be directly stored in and/or otherwise accessed by the memory 164 and/or the storage device 166 and/or other memory devices.

The bus 168 serves to transmit programs, data, status and other information or signals between the various components of the computer system of the controller 120. The bus 168 may be any suitable physical or logical means of connecting computer systems and components. This includes, but is not limited to, direct hard-wired connections, fiber optics, infrared, and wireless bus technologies. During operation, the programs are stored in the memory 164 and executed by the processor 162.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 162) to perform and execute the programs. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links.

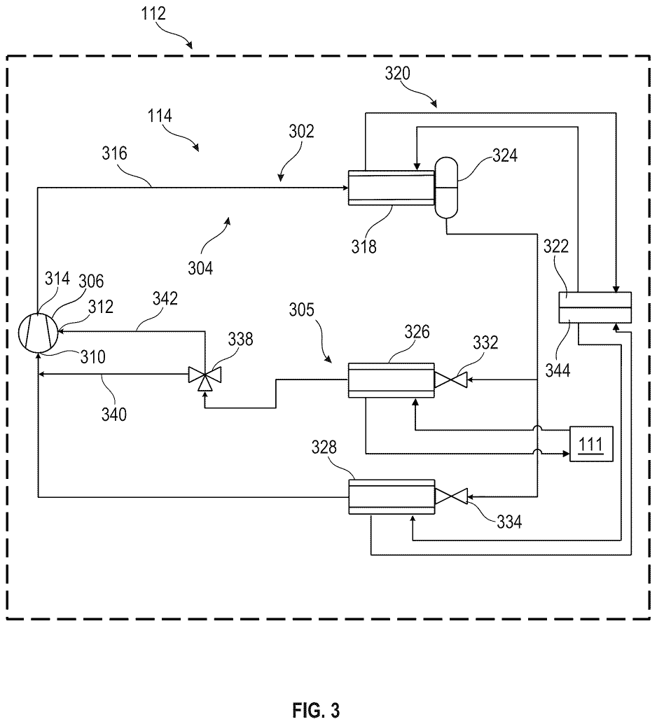

Referring to FIG. 3, aspects of the thermal management system 112 and in particular of the refrigerant system 114 are shown. The refrigerant circuit 302 includes a condenser/heat side 304 and a chiller/cool side 305. A compressor 306 increases pressure of the working fluid in the refrigerant circuit 302. The refrigerant may be a hydrocarbon such as propane (R290) or another refrigerant. The compressor 306 may be a scroll type compressor with a primary inlet port 310, a secondary inlet port 312, and an outlet port 314. The secondary inlet port 312 may be located midway along the scroll to admit refrigerant at an intermediate pressure.

The compressor 306 delivers pressurized and heated refrigerant, in a gas/vapor form, through a conduit 316 to a type of heat exchanger referred to as condenser 318. The condenser 318 is connected with a secondary heat circuit 320 that includes another heat exchanger 322. The heat exchanger 322 may be any destination or plural destinations where heat is delivered for heating or expulsion purposes. For example, the heat exchanger 322 may be in the cabin HVAC unit 116 and/or in the radiator unit 118. The cabin HVAC unit 116 is in a secondary cooling loop that does not mix working fluids with the circuit of the refrigerant system 114. As the refrigerant moves through the condenser 318 it gives up heat and is condensed to a liquid form. A receiver-dryer 324 receives the liquid refrigerant and allows space for refrigerant volume modulation and may contain a material such as a desiccant to capture any moisture and a filter to trap particulate.

Following the receiver-dryer 324, the liquid refrigerant is then directed to two chillers 326 and 328 through a conduit system 330. Each of the chillers 326 and 328 is preceded by an expansion valve 332 and 334, respectively. The expansion valves 332 and 334 may be expansion control valves, such as electronic expansion valves that precisely control flow of refrigerant. The two chillers 326 and 328 with control by the expansion valves 332 and 334 may provide cooling at two independent temperatures. In general, the chiller 326 operates at higher temperatures as compared to the chiller 328. The system uses the higher temperature chiller 326 to evaporate refrigerant and control mass flow and superheat to the vapor injection secondary inlet port 312 of the compressor 306.

For the chiller 328, the expansion valve 334 effects a pressure difference between the condenser 318 side and the chiller 328 side. High-pressure liquid refrigerant on the condenser 318 side is metered into the chiller 328 depending on the cooling load level. When no cooling is required, the expansion valve 334 may be closed. When opened, the high pressure liquid refrigerant moving through the expansion valve 334 enters the chiller 328 with a drop in pressure result in refrigerant vaporization, at least in part. The refrigerant vaporization takes up available heat so that the chiller 328 is available as a source for cooling needs. As the refrigerant passes through the chiller 328 and accepts thermal energy the refrigerant changes phase from liquid to vapor. The vapor refrigerant is then directed to a three-way valve 338. The three-way valve 338 controls return of refrigerant to the compressor 306 though the primary inlet port 310 through return conduit 340 and/or the secondary inlet port 312 through return conduit 342, and the cycle repeats. The cooling provided by the chiller 328 may be used to cool a destination, which in this example is a heat exchanger 344 for air conditioning in the cabin HVAC unit 116. In other embodiments, the cooling may be used for any additional destinations and may be mixed as illustrated in FIG. 2 for temperature modulation.

The chiller 326 and the expansion valve 332 operate similar to the chiller 328 and the expansion valve 332. For the chiller 326, the expansion valve 332 effects a pressure difference between the condenser 318 side and the chiller 326 side. High-pressure liquid refrigerant on the condenser 318 side is metered into the chiller 326 depending on the cooling load level and/or a vapor injection function. When no cooling or vapor injection is required, the expansion valve 332 may be closed. When opened, the high pressure liquid refrigerant moving through the expansion valve 332 enters the chiller 326 with a drop in pressure result in refrigerant vaporization, at least in part. The refrigerant vaporization takes up available heat so that the chiller 326 is available as a source for cooling needs. As the refrigerant passes through the chiller 326 and accepts thermal energy the refrigerant changes phase from liquid to vapor. The vapor refrigerant is then directed to the three-way valve 338. The three-way valve 338 controls return of refrigerant to the compressor 306 at the primary inlet port 310 through return conduit 340 and/or at the secondary inlet port 312 through return conduit 342, and the cycle repeats. The cooling provided by the chiller 326 may be used to cool a destination, which in this example is the cooling unit 111 for cooling the battery pack 110 in a secondary cooling loop that does not mix working fluids with the circuit of the refrigerant system 114. In other embodiments, the cooling may be used for any additional destinations and may be mixed as illustrated in FIG. 2 for temperature modulation.

The cooling needs of the battery pack 110 and the cabin HVAC unit 116 may be substantially different and so the ability to provide separate cooling rates by means of the refrigerant control through the chillers 326 and 328 is advantageous. Downstream from the chillers 326 and 328, the sensor array 142 may include pressure sensors and temperature sensors that monitor and deliver parameter data to the controller 120. The pressure and temperature data is used by the controller 120 to determine the extent to which the expansion valves 332 and 334 open to admit refrigerant into the chillers 326 and 328, respectively. When the cooling load increases the refrigerant moving through the chillers 326, 328 evaporates faster and the downstream pressure and temperature increases, and the controller 120 determines that the expansion valves 332 and 334 should be opened further. When the cooling load decreases, the refrigerant moving through the chillers 326, 328 vaporizes more slowly and the downstream pressure and temperature decreases and the controller 120 determines that the expansion valves 332 and 334 should be opened less.

By injecting refrigerant vapor into the refrigerant system 114 at a specific point heating capacity may be boosted. The chiller 326 and/or the chiller 328 may be used to inject vapor into the compressor 306 at the secondary inlet port 312. This injected vapor, midway through the scroll f the compressor 306 boosts the heating of the refrigerant. As a result, increased heat transfer occurs at the condenser 318 due to a higher temperature differential and efficiency is increased. In embodiments, the vapor injection may be primarily or exclusively provided by the chiller 326.

In the refrigeration system of FIG. 3, various components including the compressor 306, the expansion valves 332, 334 and the three-way valve 338 are communicatively coupled with the controller 120. Referring to FIG. 4, a process 400 of controlling the aforementioned valves is outlined in flow chart form. As will be appreciated in light of this disclosure, the order of operations within the process 400 is not limited to the sequential execution as illustrated in FIG. 4 and may be performed in one or more varying orders as applicable and in accordance with the present disclosure. In additional embodiments, additional steps may be included in the process 400 and/or some steps may be omitted from the process 400.

The process 400 may be implemented in connection with the vehicle 100 of FIG. 1 and the thermal management system 112 thereof, including the control system and the controller 120 thereof. The process 400 may begin 402, such as when operation of the vehicle 100 is started. In certain embodiments, the process 400 begins 402 when one or more events occur to indicate that operation of the vehicle 100 is taking place or about to take place. In various embodiments, the event(s) triggering the starting of the process 400 are determined based on sensor data from one or more of the sensors of the sensor array 142 of FIG. 2 (e.g., from ignition sensors in certain embodiments). Upon beginning, the process 400, via the controller 120, monitors the sensor array 142. The process 400 continues on to determine 404 whether operation of the refrigerant system 114 is required. For example, if the cabin HVAC unit 116 is turned on to call for heat or cooling, the compressor 306 may be started. Based on the monitoring of the sensor array 142 and the destination devices and systems of the thermal management system 112 for heating and cooling requirements, the controller 120 sets 406 the state of the expansion valves 332 and 334 and of the three-way valve 338. The controller 120 continues to monitor 408 the sensor array 142 and the various devices of the thermal management system 112 to modulate the expansion valves 332 and 334 and the three-way valve 338 and returns to the determine 404 step and continues therefrom. When the cooling and heating requirements end or when the vehicle 100 is shut down, the process 400 ends 410.

Referring to FIG. 5, a matrix/chart of the control logic used in the process 400 is specified. In general, the top row 502 indicates the load level placed on the chiller 328, which may be considered a primary chiller. In this regard, the entry 1,1 is not used, the entry 1,2 (502) is “chiller 328 no load demand,” the entry 1,3 (504) is “chiller 328 low load demand,” and the entry 1,4 (506) is “chiller 328 high load demand.” The leftmost column indicates the load level placed on the chiller 326, which may be considered a secondary chiller. In this regard, the entry 2,1 (508) is “chiller 326 no load demand,” the entry 3,1 (510) is “chiller 326 low load demand,” and the entry 4,1 (512) is “chiller 326 high load demand.” The designation of low load demand and high load demand is determined according to the specifics of the thermal management system 112. In the current embodiment, an exemplary cutoff between low load and high load is less than or equal to one kilowatt versus more than one kilowatt of load demand. In other words, the high load threshold is one kilowatt so that above the high load threshold there is a high load and below the high load threshold there is a low load. In other applications the designated separation between low and high loading will be different and may be determined by the ability o the chillers 326 and 328 to supply the loading.

At entry 2,2 (514) there is no load demand on either chiller 326, 328 and so the controller 120 sets the refrigerant system 114 to off. The compressor 306 is off.

At entry 2,3 (516) there is no load demand on the chiller 326 and there is a low load demand on the chiller 328. For example, no cooling of the battery pack 110 is needed and moderate cooling of the cabin 108 is requested. The controller 120 operates the compressor 306 and opens the expansion valve 334 with superheat control meaning the refrigerant temperature is controlled to have an actual temperature higher than its saturated vapor temperature. Specifically, the measured or calculated temperature at the exit of the chiller 328is used to control the open area of the expansion valve at 334 at the inlet of the heat exchanger. The superheat level is maintained within a target range of the saturated vapor temperature. The expansion valve 332 is maintained in a closed condition. The three-way valve 338 is open only to the return conduit 340 and the primary inlet port 310. There is no flow to the return conduit 342 and the secondary inlet port 312 and no vapor injection.

At entry 2,4 (518) there is no load demand on the chiller 326, and there is a high load demand on the chiller 328. For example, cooling of the battery pack 110 is not needed, and high cooling of the cabin 108 is requested. The controller 120 operates the compressor 306 and opens the expansion valve 334 with superheat control. The expansion valve 332 is opened with mass flow control. Mass flow control means the measured or calculated mass flow through the chiller 326 is used to control the open area of the expansion valve 332 to provide a target temperature. In embodiments, a downstream pressure target point could be used in lieu of a mass flow target. The three-way valve 338 is open to the return conduit 340 and the primary inlet port 310, and is also open to the return conduit 342 and the secondary inlet port 312 with superheat control and vapor injection into the compressor 306.

At entry 3,2 (520) there is no load demand on the chiller 328 and a low load demand on the chiller 326. The controller 120 operates the compressor 306. The expansion valve 334 is maintained closed. The expansion valve 332 is controlled open with superheat control. The three-way valve 338 is open only to the return conduit 340 and the primary inlet port 310. There is no vapor injection to the secondary inlet port 312.

At entry 3,3 (522) there is a low load demand on both chillers 326 and 328. The controller 120 operates the compressor 306. The controller 120 opens the expansion valve 334 with superheat control. The controller 120 open the expansion valve 332 with superheat control. The three-way valve 338 is open from chillers 226, 228 to the return conduit 340 and the primary inlet port 310 only. There is no vapor injection.

At entry 3,4 (524) there is a low load demand on the chiller 326 and a high load demand on the chiller 328. The controller 120 operates the compressor 306. The controller 120 opens the expansion valve 334 with superheat control. The controller 120 opens the expansion valve 332 with mass flow control. The controller 120 opens the three-way valve 338 to proportion flow between the primary inlet port 310 and the secondary inlet port 312 with vapor injection.

At entry 4,2 (526) there is a high load demand on the chiller 326 and no load demand on the chiller 328. The controller 120 operates the compressor 306. The controller 120 controls the expansion valve 334 to be maintained closed. The expansion valve 332 is controlled open with superheat control. The controller 120 opens the three-way valve 338 to proportion flow between the primary inlet port 310 and the secondary inlet port 312 with vapor injection.

At entry 4,3 (528) there is a high load demand on the chiller 326 and a low load demand on the chiller 328. The controller 120 operates the compressor 306. The controller opens the expansion valve 334 with mass flow control. The controller 120 opens the expansion valve 332 with superheat control. The controller 120 opens the three-way valve 338 to proportion flow between the primary inlet port 310 and the secondary inlet port 312 with vapor injection.

At entry 4,4 (530) there is a high load demand on both chillers 326 and 328. The controller 120 operates the compressor 306. The controller 120 opens both the expansion valve 332 and the expansion valve 334 with superheat control and with proportioning flow based on priority of the load demand. The controller 120 opens the three-way valve 338 to proportion flow between the primary inlet port 310 and the secondary inlet port 312 with vapor injection.

As described, refrigerant can still flow through the chiller 326 with control of the expansion valve 332 for the purpose of vapor injection when the coolant flow to the cooling unit 111 of the battery pack 110 is off, in order to not cool that secondary loop. Coolant side mechanization means the coolant streams from the chillers 326, 328 and even from the condenser 318 can be intermixed downstream to achieve intermediate temperatures as desired. This is achieved with multi-port coolant valves with many options contemplated.

In the aforementioned manner, systems and methods provide dual temperature cooling with a minimum of hardware requirements. A secondary loop R290 refrigeration system with vapor injection and two chillers simultaneously runs the chillers at different operating temperatures while avoiding excessive superheat on the higher temperature chiller. The system uses two chillers to maintain cooling of two coolant loops at different temperatures. There are expansion valves upstream of the chillers to control the mass flow and superheat through the chillers. The system uses the higher temperature chiller to evaporate refrigerant and control mass flow and superheat to the vapor injection port of the compressor. A three-way refrigerant control valve downstream of the chillers is controlled in modes including: 1. To fully separate the suction side flows from the chillers to the compressor; 2. To fully combine the suction side flows from the chillers to the compressor with no vapor injection; and 3. To blend the two suction flow streams with a partial stream going to the vapor injection (secondary) port of the compressor and partial stream mixing from the higher temperature chiller mixing with the stream from the lower temperature chiller with added superheat. The blending optimizes system performance and efficiency over a very broad range of system conditions and demands. The system does not have a separate vapor injection port economizer or flash gas device with expansion valve reducing hardware requirements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for thermal control comprising:
a compressor;
a condenser;
a first chiller;
a second chiller;
a refrigerant circuit in which the compressor, the condenser, the first chiller and the second chiller are connected; and
a controller configured to simultaneously operate the first and the second chillers at different operating temperatures.

2. The system for thermal control of claim 1, comprising a valve disposed upstream from the first chiller in the refrigerant circuit, wherein the controller is in communication with the valve and is configured to control the valve to inject refrigerant in vapor form from the first chiller into the compressor.

3. The system for thermal control of claim 1, comprising a valve disposed upstream from the first chiller in the refrigerant circuit, and comprising a cooling unit coupled in a secondary cooling circuit with the first chiller, wherein the controller is in communication with the valve and is configured to control the valve to inject refrigerant in vapor form from the first chiller into the compressor including when the cooling unit has no cooling demand.

4. The system for thermal control of claim 1, comprising:
a cooling unit coupled in a first secondary cooling circuit with the first chiller; and
a cabin heating, ventilating and air conditioning (HVAC) unit connected in a second secondary cooling circuit with the second chiller,
wherein the controller is configured to operate the first chiller when the cooling unit has no demand to inject vapor into the compressor.

5. The system for thermal control of claim 1, comprising:
a cooling unit coupled in a first secondary cooling circuit with the first chiller; and
an HVAC unit connected in a second secondary cooling circuit with the second chiller,
wherein the controller is configured to operate the first chiller using mass flow control when the second chiller has a higher load demand than the first chiller.

6. The system for thermal control of claim 1, comprising:
a cooling unit coupled in a first secondary cooling circuit with the first chiller; and
an HVAC unit connected in a second secondary cooling circuit with the second chiller,
wherein the controller is configured to operate the first chiller with a superheat control when the second chiller has no load demand.

7. The system for thermal control of claim 1, comprising:
a cooling unit coupled in a first secondary cooling circuit with the first chiller; and
a HVAC unit connected in a second secondary cooling circuit with the second chiller,
wherein the controller is configured to operate the second chiller with superheat control when the first chiller has no load demand.

8. The system for thermal control of claim 1, comprising:
a cooling unit coupled in a first secondary cooling circuit with the first chiller; and
a HVAC unit connected in a second secondary cooling circuit with the second chiller,
wherein the controller is configured to operate both the first chiller and the second chiller with superheat control when there is a load demand below a high load threshold on both the first chiller and the second chiller.

9. The system for thermal control of claim 1, comprising:
a cooling unit coupled in a first secondary cooling circuit with the first chiller; and
a HVAC unit connected in a second secondary cooling circuit with the second chiller,
wherein the controller is configured to operate the second chiller with superheat control and the first chiller with mass flow control when there is no load demand on the first chiller and a load demand on the second chiller above a high load threshold.

10. The system for thermal control of claim 1, comprising a three-way valve connected in the refrigerant circuit between the first and second chillers and the compressor.

11. A method for thermal control comprising:
constructing a refrigerant circuit in which a compressor, a condenser, a first chiller and a second chiller are connected; and
operating simultaneously and by a controller the first and the second chillers at different operating temperatures.

12. The method for thermal control of claim 11, comprising:
including a valve disposed upstream from the first chiller in the refrigerant circuit;
connecting the controller in communication with the valve; and
controlling, by the controller, the valve to inject refrigerant in vapor form from the first chiller into the compressor.

13. The method for thermal control of claim 11, comprising:
including a valve disposed upstream from the first chiller in the refrigerant circuit;
coupling a cooling unit in a secondary cooling circuit with the first chiller;
connecting the controller in communication with the valve; and
controlling, by the controller, the valve to inject refrigerant in vapor form from the first chiller into the compressor including when the cooling unit has no cooling demand.

14. The method for thermal control of claim 11, comprising:
coupling a cooling unit in a first secondary cooling circuit with the first chiller;
connecting a cabin heating, ventilating and air conditioning (HVAC) unit in a second secondary cooling circuit with the second chiller; and
operating, by the controller and when the cooling unit has no demand, the first chiller to inject vapor into the compressor.

15. The method for thermal control of claim 11, comprising:
coupling a cooling unit in a first secondary cooling circuit with the first chiller;
connecting an HVAC unit in a second secondary cooling circuit with the second chiller; and
operating, by the controller, the first chiller using mass flow control when the second chiller has a higher load demand than the first chiller.

16. The method for thermal control of claim 11, comprising:
coupling a cooling unit in a first secondary cooling circuit with the first chiller;
connecting an HVAC unit in a second secondary cooling circuit with the second chiller; and
operating, by the controller, the first chiller with a superheat control when the second chiller has no load demand.

17. The method for thermal control of claim 11, comprising:
coupling a cooling unit in a first secondary cooling circuit with the first chiller;
connecting an HVAC unit in a second secondary cooling circuit with the second chiller; and
operating, by the controller, the second chiller with superheat control when the first chiller has no load demand.

18. The method for thermal control of claim 11, comprising:
coupling a cooling unit in a first secondary cooling circuit with the first chiller;
connecting an HVAC unit in a second secondary cooling circuit with the second chiller; and
operating, by the controller, both the first chiller and the second chiller with superheat control when there is a load demand below a high load threshold on both the first chiller and the second chiller.

19. The method for thermal control of claim 11, comprising:
coupling a cooling unit in a first secondary cooling circuit with the first chiller;
connecting an HVAC unit in a second secondary cooling circuit with the second chiller;
operating, by the controller, the second chiller with superheat control and the first chiller with mass flow control when there is no load demand on the first chiller and a load demand on the second chiller above a high load threshold; and
positioning a three-way valve connected in the refrigerant circuit between the first and second chillers and the compressor.

20. A system for thermal control in a vehicle comprising:
a compressor having a primary port and a secondary port;
a condenser connected in a secondary heating circuit with a heating, ventilating and air conditioning (HVAC) unit;
a first chiller connected in a first secondary cooling circuit with a cooling unit of a battery pack;
a second chiller connected in a second secondary cooling circuit with the HVAC unit;
a refrigerant circuit in which the compressor, the condenser, the first chiller and the second chiller are connected;
a three-way valve connected in the refrigerant circuit between the first and second chillers and the compressor, the three-way valve coupled with the compressor at both the primary port and the secondary port; and
a controller configured to simultaneously operate the first and the second chillers at different operating temperatures.
